(19) United States
(12) Patent Application Publication
(10) Pub. No.: US 2025/0105262 A1
(43) Pub. Date: Mar. 27, 2025

(54) NEGATIVE ELECTRODE ACTIVE MATERIAL AND RECHARGEABLE LITHIUM BATTERY INCLUDING SAME

(71) Applicant: SAMSUNG SDI CO., LTD., Yongin-si (KR)

(72) Inventors: Yookyung KIM, Yongin-si (KR); Deok-Hyun KIM, Yongin-si (KR); Youngugk KIM, Yongin-si (KR)

(21) Appl. No.: 18/654,136

(22) Filed: May 3, 2024

(30) Foreign Application Priority Data
Sep. 22, 2023 (KR) 10-2023-0127375

(51) Int. Cl. H01M 4/36; C01B 33/021; H01M 4/02; H01M 4/38; H01M 10/052

(52) U.S. Cl. CPC H01M 4/366; C01B 33/021; H01M 4/386; H01M 10/052; C01P 2002/74; C01P 2004/50; C01P 2004/61; C01P 2004/80; C01P 2006/40; H01M 2004/021; H01M 2004/027

(57) ABSTRACT

A negative electrode active material, including primary particles including silicon nanoparticles, and a metal coating layer including a metal material surrounding a surface of each of the silicon nanoparticles; a secondary particle where the primary particles are agglomerated; and an amorphous carbon coating layer surrounding a surface of the primary particles and a surface of the secondary particle, wherein the negative electrode active material has a span as defined by Equation 1 of about 1.1 to about 1.6,

$$Span = ( D 90 - D 10 ) / D 50 \qquad [ Equation 1 ]$$

wherein, D10 indicates a diameter of particles having a cumulative volume of 10 volume % in a particle size distribution, D50 indicates a diameter of particles having a cumulative volume of 50 volume % in the particle size distribution, and D90 indicates a diameter of particles having a cumulative volume of 90 volume % in the particle size distribution.

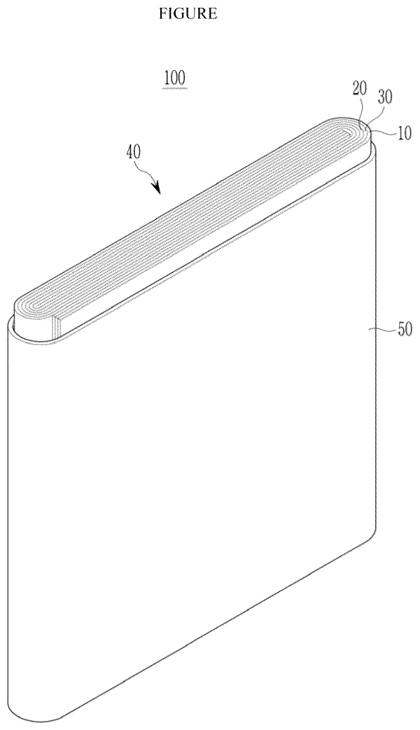

### CROSS-REFERENCE TO RELATED APPLICATION

This application claims priority to and the benefit of Korean Patent Application No. 10-2023-0127375 filed in the Korean Intellectual Property Office on Sep. 22, 2023, the entire contents of which are incorporated herein by reference.

### BACKGROUND

### 1. Field

Embodiments relate to a negative electrode active material a rechargeable lithium battery including the same.

### 2. Description of the Related Art

Recently, the rapid increase in electronic devices such as mobile phones, laptop computers, and electric vehicles using batteries has resulted in the surprising increases in demand for rechargeable batteries with relatively high capacity and lighter weight. As a result, the development of batteries with a high energy density has been required, which further requires a high-capacity negative electrode active material. Recently, it has been attempted to use a Si negative electrode active material as the high-capacity negative electrode active material.

### SUMMARY

Embodiments are directed to a negative electrode active material, including primary particles including silicon nanoparticles, and a metal coating layer including a metal material surrounding a surface of each of the silicon nanoparticles; a secondary particle where the primary particles are agglomerated; and an amorphous carbon coating layer surrounding a surface of the primary particles and a surface of the secondary particle, wherein the negative electrode active material has a span as defined by Equation 1 of about 1.1 to about 1.6;

$$Span = ( D 90 - D 10 ) / D 50 \qquad [ Equation 1 ]$$

wherein, D10 indicates a diameter of particles having a cumulative volume of 10 volume % in a particle size distribution, D50 indicates a diameter of particles having a cumulative volume of 50 volume % in the particle size distribution, and D90 indicates a diameter of particles having a cumulative volume of 90 volume % in the particle size distribution.

The span may be about 1.1 to about 1.5.

The metal material may include a metal or a metal compound.

The metal compound may include another metal oxide, a metal nitride, or a combination thereof.

The metal material may include a metal capable of alloying with lithium.

The metal may include an alkali metal, an alkaline-earth metal, a Group 13 element, a Group 14 element, a Group 15 element, a Group 16 element, a transition metal, a rare earth element, or a combination thereof.

The metal may include Ag, Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, or a combination thereof.

The metal may include Ag.

An amount of the metal material may be about 0.01 wt % to about 20 wt % based on a total weight of the negative electrode active material.

An amount of the metal material may be about 0.05 wt % to about 15 wt % based on a total weight of the negative electrode active material.

The amorphous carbon coating layer may further include a metal material.

The negative electrode active material may have a ratio of a peak intensity (I_{metal 111}/I_{Si 111}) of a diffraction peak intensity (Iₘₑₜₐₗ₍₁₁₁₎) derived from a metal(111) detected at 2θ=about 37.5° to about 40.0° relative to a diffraction peak intensity (I_{Si(111)}) derived from Si(111) detected at 2θ=about 27.5° to about 29.5° of about 0.05 to about 0.5 in measurement of X-ray diffraction intensity.

The metal coating layer may continuously cover the surface of each of the silicon nanoparticles.

The metal coating layer may have a thickness of about 1 nm to about 30 nm.

The silicon nanoparticles may have a particle diameter of about 1 nm to about 1,000 nm.

The silicon nanoparticles may have a particle diameter of about 10 nm to about 200 nm.

The amorphous carbon coating layer may have a thickness of about 1 nm to about 2 km.

An amount of the silicon nanoparticle may be about 44 wt % to about 65 wt % based on a total weight of the negative electrode active material.

An amount of the amorphous carbon coating layer may be about 34 wt % to about 46 wt % based on a total weight of the negative electrode active material.

The embodiments may be realized by providing a rechargeable lithium battery, including a negative electrode including the negative electrode active material of claim 1; a positive electrode; and an electrolyte.

### BRIEF DESCRIPTION OF THE DRAWING

Features will become apparent to those of skill in the art by describing in detail exemplary embodiments with reference to the attached drawing in which:

the FIGURE is an exploded perspective view schematically showing a rechargeable lithium battery according to an embodiment.

### DETAILED DESCRIPTION

Example embodiments will now be described more fully hereinafter with reference to the accompanying drawing; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing FIGURE, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Expressions in the singular include expressions in plural unless the context clearly dictates otherwise. The term “combination thereof may include a mixture, a laminate, a complex, a copolymer, an alloy, a blend, a reactant of constituents.

The term “comprise”, “include” or “have” are intended to designate that the performed characteristics, numbers, step, constituted elements, or a combination thereof is present, but it should be understood that the possibility of presence or addition of one or more other characteristics, numbers, steps, constituted element, or a combination are not to be precluded in advance. When an element is referred to as being “directly on” another element, there are no intervening elements present.

In some embodiments, herein, “layer” includes a shape totally formed on the entire surface or a shape partial surface, when viewed from a plane view.

As used herein, “or” is not to be construed in an exclusive sense, for example, “A or B” may be interpreted to include A, B, A+B, or the like.

In the present disclosure, when a definition is not otherwise provided, a particle diameter or size may indicate an average particle diameter. The average particle diameter indicates an average value of the diameter of the particles depending on a cumulative volume in the particle size distribution of particles included in the negative electrode active material. The average particle size (D50) may be measured by a suitable method, e.g., by a particle size analyzer, or by a transmission electron microscopic image, or a scanning electron microscopic image. In some embodiments, a dynamic light-scattering measurement device may be used to perform a data analysis, and the number of particles may be counted for each particle size range, and from this, the average particle diameter (D50) value may be easily obtained through a calculation.

A negative electrode active material according to some embodiments may having a span as defined by Equation 1 of, e.g., about 1.1 to about 1.6; a secondary particle where primary particles may be agglomerated, the primary particles may include silicon nanoparticles and a metal coating layer including a metal material surrounding a surface of the each of the silicon nanoparticles; and an amorphous carbon coating layer surrounding a surface of the primary particles and a surface of the secondary particle

$$Span = ( D 90 - D 10 ) / D 50 \qquad [ Equation 1 ]$$

In Equation 1, D10 may indicate a diameter of particles having a cumulative volume of 10 volume % in the particle size distribution, D50 may indicate a diameter of particles having a cumulative volume of 50 volume % in the particle size distribution, and D90 may indicate a diameter of particles having a cumulative volume of 90 volume % in the particle size distribution.

In an implementation, the span as defined by Equation 1 may be, e.g., about 1.1 to about 1.55, or about 1.1 to about 1.5. A span of the negative electrode active material within the above ranges may indicate that the fine powder negative electrode active material may be substantially not included in the negative electrode active material. In an implementation, fine powders which have a size of, e.g., about 1 μm or less and typically have an unspecified shape may be rarely included, and thus the negative electrode active material may have a low specific surface area, thereby reducing side reactions with an electrolyte and improving cycle-life.

The negative electrode active material according to one or more embodiments may have low specific surface area, e.g., a low BET specific surface area, and the specific surface area may be, e.g., about 0.5 m²/g to about 2 m²/g, about 0.8 m²/g to about 2 m²/g, or about 0.8 m²/g to about 1.5 m²/g. A specific surface area in the above ranges may be a lower value than the specific surface area of a silicon-carbon composite negative electrode active material, which may be approximately 3 m²/g.

The negative electrode active material according to one or more embodiments may include primary particles and secondary particles where the primary particles may be agglomerated, and an amorphous carbon coating layer surrounding the surface of the secondary particles.

In an implementation, the primary particle may include silicon nanoparticles and a metal coating layer surrounding the silicon nanoparticles on a surface of the silicon nanoparticles, and the metal coating layer may include a metal material. The amorphous carbon coating layer may include a metal material.

In an implementation, the metal included in the metal coating layer may be the same as the metal included in the amorphous carbon coating layer.

In the negative electrode active material according to one or more embodiments, the primary particles may be silicon nanoparticles surrounded by the metal coating layer, and may include the coating layer in the form of a layer, including the metal material, substantially and continuously on, e.g., covering, the surface of the silicon nanoparticles. In an implementation, the surface of the silicon nanoparticles may be completely covered by the metal coating layer, thereby leaving no surface of the silicon nanoparticles exposed. In an implementation, positioning the metal coating layer in the form of a layer may indicate that the metal coating layer, which may be positioned at a predetermined thickness along the surface of the silicon nanoparticles, may be positioned in area contact with the silicon nanoparticles. This may improve the internal conductivity of the negative electrode active material, thereby improving uniformity of charge and discharge, and increasing silicon utilization rate by the improvement in the electrical conductivity caused by the coating layer, and by reducing side reactions. In an implementation, if the metal coating layer is discontinuously presented on the surface of the silicon nanoparticles, e.g., does not uniformly cover the surface of the silicon nanoparticles, in the form of an island-type or point-contact arrangement, the effects from the metal coating layer formation may be insignificant. In an implementation, an island-type form may indicate that the metal coating layer is only located at a specific position, e.g., rather than continuously, on the surface of the silicon nanoparticles.

A thickness of the metal coating layer may be, e.g., about 1 nm to about 30 nm, about 1 nm to about 20 nm, or about 5 nm to about 20 nm. Maintaining the thickness of the metal coating layer within the above ranges may help ensure that a larger improvement effect in the electrical conductivity may be obtained by the metal coating layer, and that the inside of the active material may be used more uniformly if the battery is operated.

In the negative electrode active material, the amorphous carbon coating layer may surround the surface of, e.g., cover the surface of, the secondary particle and the primary particles, and, e.g., it may be between the primary particles and may be also on the surface of the secondary particle.

In an implementation, the amorphous carbon coating layer may include a metal material. The metal material included in the amorphous carbon coating layer may be present by the inclusion of some of the metal material which may be prepared during the preparation of the metal coating layer, e.g., in order to locate it on the surface of the silicon nanoparticles, in the amorphous carbon coating layer in the preparation of the negative electrode active material. Thus, the metal included in the amorphous carbon coating layer may be the same metal of the metal coating layer.

In an implementation, the metal material included in the metal coating layer and the amorphous carbon coating layer may be a metal or a metal compound. The metal compound may include metal oxide, metal nitride, or a combination thereof.

The metal may be a metal capable of alloying with lithium and may include, e.g., an alkali metal, an alkaline-earth metal, a Group 13 element, a Group 14 element, a Group 15 element, a Group 16 element, a transition metal, a rare earth element, or a combination thereof. In an implementation, the metal may include, e.g., Ag, Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof. In an implementation, the metal may be Ag.

Because the coating layer including the metal may be distributed on the surface of the primary particles and the surface of the secondary particles, e.g., inside and outside of the active material, the conductivity of the active material may be enhanced in both inside and outside.

An amount of the metal material may be, based on a total weight of the negative electrode active material, e.g., about 0.01 wt % to about 20 wt %, about 0.05 wt % to about 15 wt %, or about 0.01 wt % to about 10 wt %. In an implementation, the amount of the metal material may be the total amount of the metal material included in the negative electrode active material. Maintaining the amount of the metal material within the above ranges may help ensure the conductivity of the active material may be further improved, allowing for a more uniform utilization of the inside of the active material.

In the negative electrode active material according to one or more embodiments, in measurement of X-ray diffraction intensity, a peak intensity ratio (I_{metal 111}/I_{Si 111}) of a diffraction peak intensity (Iₘₑₜₐₗ₍₁₁₁₎) derived from a metal(111) detected at 2θ=about 37.5° to about 40.0° relative to a diffraction peak intensity (I_{Si(111)}) derived from Si(111) detected at 2θ=about 27.5° to about 29.5° may be, e.g., about 0.05 to about 0.5. The ratio of peak intensity (Iₘₑₜₐₗ₍₁₁₁₎/I_{Si(111)}) may be, e.g., about 0.2 to about 0.4, or about 0.1 to about 0.4. The peak intensity ratio may depend on the type of the metal, and, e.g., the peak intensity ratio may be a satisfied value, if the metal is Ag. In an implementation, the diffraction peak intensity ratio may be I_{Ag(111)}/I_{Si(111)}.

The peak intensity ratio (I_{Ag(111)}/I_{Si(111)}) within the range may indicate that Si and the metal (e.g., Ag) exist in the structure of the negative electrode active material at a predetermined ratio, which may indicate an increase in the conductivity of the negative electrode active material. Increases in the conductivity of the active material may result in the substantial and majority participation of silicon nanoparticles in the charge and discharge reaction, enabling uniform charge and discharge, thereby achieving high capacity and long cycle-life.

If an amount of the metal material is increased, the diffraction peak intensity (I_{Ag(111)}) derived from the metal, e.g., Ag may be increased, thereby increasing the peak intensity ratio (I_{Ag(111)}/I_{Si(111)}). The peak intensity ratio (I_{Ag(111)}/I_{Si(111)}) within the range may indicate the suitable inclusion of Ag. In an implementation, the peak intensity may be a height of a peak or an integral area of the peak, and in another implementation, it may be the integral area of the peak.

The X-ray diffraction intensity may be measured by using a CuKα ray as a target ray, and the measurement condition may be 2θ=about 20° to about 80°, a scan speed (°/S) of 0.044 to 0.089, and a step size (°/step) of 0.013 to 0.039. The peak intensity ratio (Iₘₑₜₐₗ₍₁₁₁₎/I_{Si(111)}), e.g., I_{Ag(111)}/I_{Si(111)} may represents a ratio of the peak intensity, e.g., a relative value, and thus, the absolute values of the peak intensity (Iₘₑₜₐₗ₍₁₁₁₎)) of the (111) plane of the metal and the peak intensity I_{Si(111)}) of the (111) plane of Si may depend on the X-ray diffraction analysis measurement condition, but it may be important to note that the peak intensity ratio (Iₘₑₜₐₗ₍₁₁₁₎/I_{Si(111)}) itself rarely changes substantially.

In an implementation, a particle diameter of the metal material included in the amorphous carbon coating layer may be about, e.g., 1 nm to about 30 nm, and in another implementation, may be, e.g., about 1 nm to about 20 nm, or about 5 nm to about 20 nm. Maintaining the particle diameter of the metal material within the above ranges may help ensure the inside of the active material may be more uniformly used, during battery operation.

In an implementation, a particle diameter of the silicon nano particle may be, e.g., about 10 nm to about 1,000 nm, and in another implementation, it may be, e.g., about 10 nm to about 200 nm, or about 20 nm to about 150 nm. Maintaining the average particle diameter of the silicon nano particles within the above ranges may help ensure the extreme volume expansion caused during charge and discharge may be suppressed, and a breakage of the conductive path due to crushing of particle may be prevented.

In the amorphous carbon coating layer, amorphous carbon may be, e.g., soft carbon, hard carbon, mesophase pitch carbide, sintered coke, or a combination thereof. A thickness of the amorphous carbon coating layer may be, e.g., about 1 nm to about 2 m, about 1 nm to about 500 nm, about 10 nm to about 300 nm, or about 20 nm to about 200 nm. Maintaining the thickness of the amorphous carbon coating layer within the above ranges may help ensure silicon volume expansion may be better suppressed during charge and discharge.

In the negative electrode active material, an amount of the silicon nanoparticle may be, based on the total weight of the negative electrode active material, e.g., about 44 wt % to about 65 wt %, or about 52 wt % to about 62 wt %. An amount of the amorphous carbon coating layer may be, based on the total weight of the negative electrode active material, e.g., about 34 wt % to about 46 wt %, or about 36 wt % to about 41 wt %.

The negative electrode active material according to some embodiments may be prepared by the following procedures.

Micrometer-sized silicon particles, a metal material precursor, and a dispersant may be mixed in a solvent. The mixing may be carried out by a ball milling using zirconia balls, or the like. By the mixing, a pulverization may be carried out to prepare nano-sized silicon primary particles. The solvent may include an organic solvent, e.g., ethanol, methanol, propanol, or the like. A particle diameter of the silicon primary particles may be, e.g., about 1 nm to about 1000 nm, about 10 nm to about 100 nm, or about 20 nm to about 150 nm. The dispersant may be, e.g., stearic acid, boron nitride (BN), MgS, polyvinyl pyrrolidone (PVP), or a combination thereof.

A mixing ratio of the silicon particles and the metal material precursor may be adjusted in order to have a mixing ratio of silicon and the metal to be, e.g., about 100:1 to about 100:30 by weight, or about 100:1 to about 100:25 by weight. In mixing, an amount of the dispersant may be used in the amount suitable for the silicon particles and the metal material precursor to be well dispersed in the solvent, e.g., it may be about 100:1 to about 100:30 by weight or about 100:10 to about 100:30 by weight.

The metal material precursor may be, e.g., a metal, metal nitride, metal carbide, metal sulfide, metal halide, or a combination thereof. The halide may be, e.g., chloride or fluoride. The metal may be a metal capable of alloying with lithium, as described above. The resulting mixture may be dried. The drying process may be carried out by a spray drying. Because the drying process may be carried out by a spray drying, a dried product with more uniform particle diameter and a spherical shape, may be prepared and secondary particle where primary particles are agglomerated, may be prepared. This may locate the metal or metal oxide on a surface of the silicon primary particles. The silicon primary particles and the metal material precursor may be agglomerated together to prepare an agglomerated secondary particle. Some of the metal material precursor between the primary particles may be on the surface of the secondary particle. If the dried product may be particles having uniform particle diameter and a spherical shape, the subsequent prepared amorphous carbon layer may be more uniformly formed on the entire surface.

During the procedure, some of the metal material may also be included in the amorphous carbon which may be subsequently formed. An amorphous carbon layer may be formed on the dried product. The formation of the amorphous carbon layer may be carried out, e.g., by vapor coating with an amorphous carbon precursor gas, or mixing the dried product with an amorphous carbon precursor and carbonizing.

The amorphous carbon precursor gas may be, e.g., methane (CH₄) gas, ethylene (C₂H₄) gas, acetylene (C₂H₂) gas, propane (C₃H₈) gas, propylene (C₃H₆) gas, or a combination thereof, and the amorphous carbon precursor may be, e.g., petroleum coke, coal coke, petroleum pitch, coal pitch, green cokes, or a combination thereof.

The carbonization may be carried out at, e.g., about 600° C. to about 1,000° C. In the carbonization, the dispersant may be removed. The carbonization may be carried out, e.g., under an N₂ atmosphere, a helium atmosphere, or a combination thereof.

Performing the carbonization in the above the temperature range may help ensure that the excessive growth of Si particles may be suppressed, the formation of SiC may be suppressed, and the electrical conductivity of amorphous carbon may be simultaneously enhanced. According to the carbonization, the amorphous carbon precursor may be converted to amorphous carbon, which may surround the surface of the secondary particle, thereby preparing an amorphous carbon layer. Some amorphous carbon may be inserted into pores formed between primary particles to be positioned on the surface of the primary particles, thereby surrounding the surface of the primary particles. Maintaining the atmosphere of the carbonization in the above conditions may help ensure the oxidation of silicon and formation of SiC may be effectively suppressed, thereby reducing resistance of the active material.

Thereafter, the heat-treated product may be subjected to pulverization. The pulverization may be carried out by using, e.g., a sieve in order to have a span (defined by Equation 1) of the negative electrode active material to be, e.g., about 1.1 to about 1.6. In an implementation, the pulverization may be performed to obtain an active material with a particle size such that the span obtained from D10, D50, and D90 of the active material may be, e.g., about 1.1 to about 1.6.

Another implementation provides a rechargeable lithium battery including a negative electrode, a positive electrode, and an electrolyte. The negative electrode may include, e.g., a current collector, and a negative electrode active material layer on the current collector and including a negative electrode active material layer including the negative electrode active material according to one or more embodiments.

The negative electrode active material according to some embodiments may include the negative electrode active material as a first negative electrode active material and may include, e.g., crystalline carbon, as a second negative electrode active material. A mixing ratio of the first negative electrode active material and the second negative electrode active material may be, e.g., a weight ratio of about 80:20 to about 90:10. In an implementation, the negative electrode active material may include the first negative electrode active material and the second negative electrode active material at a weight ratio of, e.g., about 85:15 to about 90:10.

In the negative electrode active material layer, an amount of the negative electrode active material may be, e.g., about 95 wt % to about 98 wt %, based on the total weight of the negative electrode active material layer.

In an implementation, the negative electrode active material layer may include a binder or a conductive material. The amount of the binder may be, e.g., about 1 wt % to about 5 wt % based on the total weight of the negative electrode active material layer. The amount of the conductive material may be, e.g., about 1 wt % to about 5 wt % based on the total weight of the negative electrode active material layer.

The binder may help improve binding properties of negative electrode active material particles with one another and with a current collector. The binder may be a non-aqueous binder, an aqueous binder, or a combination thereof.

The non-aqueous binder may include, e.g., an ethylene propylene copolymer, polyacrylonitrile, polystyrene, polyvinylchloride, carboxylated polyvinylchloride, polyvinyl fluoride, polyurethane, polytetrafluoroethylene, polyvinylidene fluoride, polyethylene, polypropylene, polyamide imide, polyimide, or a combination thereof.

The aqueous binder may include, e.g., styrene-butadiene rubber (SBR), an acrylated styrene-butadiene rubber (ABR), an acrylonitrile-butadiene rubber, an acrylic rubber, a butyl rubber, a fluorine rubber, polyethylene oxide, polyvinyl pyrrolidone, polypropylene, polyepichlorohydrin, polyphosphazene, an ethylene propylene diene copolymer, polyvinyl pyridine, chlorosulfonated polyethylene, latex, polyester resin, an acrylic resin, a phenolic resin, an epoxy resin, polyvinyl alcohol, or a combination thereof.

The negative electrode binder may include, e.g., a cellulose compound, and may include the cellulose compound, together with the aqueous binder. The cellulose compound may include one or more of carboxymethyl cellulose, hydroxypropyl methylcellulose, methyl cellulose, or alkali metal salts thereof. The alkali metal may be Na, K, or Li. The cellulose compound may serve as a thickener and may impart viscosity to serve as a binder. In an implementation, it may be used by appropriately adjusting it within the ranged amount of the binder described above, e.g., the amount of the cellulose compound may be about 0.1 parts by weight to about 3 parts by weight based on 100 parts by weight of the negative electrode active material.

The conductive material may impart conductivity to the electrode, and a suitable material that does not cause chemical change and conducts electrons may be used in the battery. Examples thereof may include a carbon material such as natural graphite, artificial graphite, carbon black, acetylene black, ketjen black, a carbon fiber; a metal material including copper, nickel, aluminum, silver, etc. in a form of a metal powder or a metal fiber; a conductive polymer such as a polyphenylene derivative; or a mixture thereof.

The current collector may include a copper foil, a nickel foil, a stainless steel foil, a titanium foil, a nickel foam, a copper foam, a polymer substrate coated with a conductive metal, and a combination thereof.

The positive electrode may include a current collector and a positive electrode active material layer on the current collector. The positive electrode active material may include lithiated intercalation compounds that reversibly intercalate and deintercalate lithium ions. In an implementation, at least one of a composite oxide of lithium and a metal, e.g., cobalt, manganese, nickel, or combinations thereof may be used. In an implementation, the compounds represented by one of the following chemical formulae may be used. LiₐA_{1-b}X_{b}D¹₂ (0.90≤a≤1.8, 0≤b≤0.5); LiₐA_{1-b}X_{b}O_{2-c1}D¹_{c1} (0.90≤a≤1.8, 0≤b≤0.5, 0≤c1≤0.05); LiₐE_{1-b}X_{b}O_{2-c1}D¹_{c1} (0.90≤a≤1.8, 0≤b≤0.5, O≤c1≤0.05); LiₐE_{2-b}X_{b}O_{4-c1}D¹_{c1}(0.90≤a≤1.8, 0≤b≤0.5, O≤c1≤0.05); LiₐNi_{1-b-c}Co_{b}X_{c}D¹_{α} (0.90≤a≤1.8, 0≤b≤0.5, 0≤c≤0.5, 0<α≤2); LiₐNi_{1-b-c}Co_{b}X_{c}O_{2-α}T_{α} (0.90≤α≤1.8, 0≤b≤0.5, 0≤c≤0.5, 0≤α≤2); LiₐNi_{1-b-c}Co_{b}X_{c}O_{2-α}T₂ (0.90≤a≤1.8, 0≤b≤0.5, 0≤c≤0.5, 0<α≤2); LiₐNi_{1-b-c}Mn_{b}X_{c}D¹_{α} (0.90≤a≤1.8, 0≤b≤0.5, 0≤c≤0.5, 0≤α≤2); LiₐNi_{1-b-c}Mn_{b}X_{c}O_{2-α}T_{α} (0.90≤a≤1.8, 0≤b≤0.5, 0≤c≤0.5, 0<α<2); LiₐNi_{1-b-c}Mn_{b}X_{c}O_{2-α}T₂ (0.90≤a≤1.8, 0≤b≤0.5, 0≤c≤0.5, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1) LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃(0≤f≤2); Li_{(3-f)}Fe₂(PO₄)₃ (0≤f≤2); LiₐFePO₄ (0.90≤a≤1.8)

In the above chemical formulas, A may be Ni, Co, Mn, or combinations thereof, X may be Al, Ni, Co, Mn, Cr, Fe, Mg, Sr, V, a rare earth element, and combinations thereof, D¹ may be O, F, S, P, or combinations thereof, E may be Co, Mn, or combinations thereof, T may be F, S, P, or combinations thereof, G may be Al, Cr, Mn, Fe, Mg, La, Ce, Sr, V, or combinations thereof, Q may be Ti, Mo, Mn, or combinations thereof, Z may be Cr, V, Fe, Sc, Y, or combinations thereof, J may be V, Cr, Mn, Co, Ni, Cu, or combinations thereof, L¹ may be Mn, Al, or combinations thereof.

The compounds may have a coating layer on the surface, or may be mixed with another compound having a coating layer. The coating layer may include a coating element compound, e.g., an oxide of a coating element, a hydroxide of a coating element, an oxyhydroxide of a coating element, an oxycarbonate of a coating element, or a hydroxyl carbonate of a coating element. The compound for the coating layer may be amorphous or crystalline. The coating element included in the coating layer may include, e.g., Mg, Al, Co, K, Na, Ca, Si, Ti, V, Sn, Ge, Ga, B, As, Zr, or a mixture thereof. The coating layer may be disposed in a method having no adverse influence on properties of a positive electrode active material by using these elements in the compound, and, e.g., the method may include any coating method such as spray coating, dipping, or the like.

In the positive electrode, an amount of the positive electrode active material may be, e.g., about 90 wt % to about 98 wt %, based on the total weight of the positive electrode active material layer.

In an implementation, the positive electrode active material layer may further include a binder and a conductive material. The binder and the conductive material may each be included in an amount of, e.g., about 1 wt % to about 5 wt %, respectively based on the total amount of the positive electrode active material layer.

The binder may help improve binding properties of positive electrode active material particles with one another and with a current collector. Examples of the binder may include polyvinyl alcohol, carboxymethyl cellulose, hydroxypropyl cellulose, diacetyl cellulose, polyvinylchloride, carboxylated polyvinylchloride, polyvinyl fluoride, an ethylene oxide-containing polymer, polyvinyl pyrrolidone, polyurethane, polytetrafluoroethylene, polyvinylidene fluoride, polyethylene, polypropylene, a styrene butadiene rubber, an acrylated styrene butadiene rubber, an epoxy resin, nylon, or the like.

The conductive material may provide electrode conductivity, and a suitable electrically conductive material may be used as a conductive material unless it causes a chemical change. Examples of the conductive material may include a carbon material such as natural graphite, artificial graphite, carbon black, acetylene black, ketjen black, a carbon fiber and the like; a metal material of a metal powder or a metal fiber including copper, nickel, aluminum, silver, or the like; a conductive polymer such as a polyphenylene derivative; or a mixture thereof. The current collector may, e.g., include Al.

The electrolyte may include a non-aqueous organic solvent and a lithium salt. The non-aqueous organic solvent may serve as a medium for transmitting ions taking part in the electrochemical reaction of a battery. The non-aqueous organic solvent may include, e.g., a carbonate, ester, ether, ketone, alcohol, or aprotic solvent.

The carbonate solvent may include, e.g., dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like, the ester solvent may include methyl acetate, ethyl acetate, n-propyl acetate, dimethyl acetate, methyl propionate, ethyl propionate, propyl propionate, v-butyrolactone, decanolide, valerolactone, mevalonolactone, caprolactone, or the like. The ether solvent may include dibutyl ether, tetraglyme, diglyme, dimethoxyethane, 2-methyltetrahydrofuran, 2,5-dimethyltetrahydrofuran, tetrahydrofuran, or the like, and the ketone solvent may include cyclohexanone, or the like. The alcohol solvent may, e.g., include ethanol, isopropyl alcohol, or the like. Theaprotic solvent may include nitriles such as R—CN (wherein R may be a C2 to C20 linear, branched, or cyclic hydrocarbon group, and may include a double bond, an aromatic ring, or an ether bond, or the like); amides such as dimethylformamide; dioxolanes such as 1,3-dioxolane, 1,4-dioxolane, or the like; sulfolanes, or the like.

The organic solvent may be used alone or in a mixture. In an implementation, the organic solvent may be used in a mixture and the mixture ratio may be controlled in accordance with a desirable battery performance.

In an implementation the non-aqueous organic solvent may be mixed and used, a mixed solvent of a cyclic carbonate and a chain carbonate, a mixed solvent of a cyclic carbonate and a propionate solvent, or a mixed solvent of a cyclic carbonate, a chain carbonate, and a propionate solvent may be used. The propionate solvent may include, e.g., methyl propionate, ethyl propionate, propyl propionate, or a combination thereof.

In an implementation the cyclic carbonate and the chain carbonate or the cyclic carbonate and the propionate solvent may be mixed in a volume ratio of, e.g., about 1:1 to about 1:9 and thus performance of an electrolyte solution may be improved. In an implementation the cyclic carbonate, the chain carbonate, and the propionate solvent may be mixed in a volume ratio of, e.g., about 1:1:1 to about 3:3:4. The mixing ratios of the solvents may be appropriately adjusted according to desirable properties.

In an implementation, the organic solvent may further include an aromatic hydrocarbon solvent as well as the carbonate solvent. The carbonate solvent and aromatic hydrocarbon solvent may be mixed together in a volume ratio of, e.g., about 1:1 to about 30:1. The aromatic hydrocarbon organic solvent may be an aromatic hydrocarbon compound represented by Chemical Formula 1.

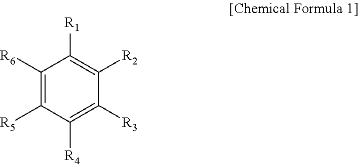

In Chemical Formula 1, R₁ to R₆ may each independently be or include, e.g., hydrogen, a halogen, a C1 to C10 alkyl group, a haloalkyl group, or a combination thereof.

In an implementation, the aromatic hydrocarbon organic solvent may include, e.g., benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, or a combination thereof.

In an implementation, the electrolyte may further include vinylethyl carbonate, vinylene carbonate, or an ethylene carbonate compound represented by Chemical Formula 2 as an additive for improving cycle life.

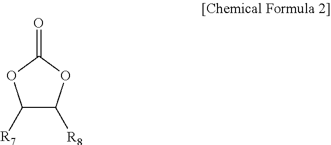

In Chemical Formula 2, R₇ and R₈ may each independently be or include, e.g., hydrogen, a halogen, a cyano group (CN), a nitro group (NO₂), or a C1 to C5 fluoroalkyl group, provided that at least one of R₇ and R₈ is or includes a halogen, a cyano group (CN), a nitro group (NO₂), or a C1 to C5 fluoroalkyl group, and R₇ and R₈ are not simultaneously hydrogen.

In an implementation, the ethylene carbonate compound may include, e.g., difluoro ethylene carbonate, chloroethylene carbonate, dichloroethylene carbonate, bromoethylene carbonate, dibromoethylene carbonate, nitroethylene carbonate, cyanoethylene carbonate, fluoroethylene carbonate, or the like. An amount of the additive for improving the cycle-life characteristics may be used within a suitable range.

The lithium salt dissolved in an organic solvent may supply a battery with lithium ions, may basically operates the rechargeable lithium battery, and may help improve transportation of the lithium ions between a positive electrode and a negative electrode. Examples of the lithium may include LiPF₆, LiBF₄, LiSbF₆, LiAsF₆, LiN(SO₂C₂F₅)₂, Li(CF₃SO₂)₂N, LiN (SO₃C₂F₅)₂, Li(FSO₂)₂N (lithium bis(fluorosulfonyl)imide: LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂), wherein x and y are natural numbers, e.g., an integer of about 1 to about 20, lithium difluoro(bisoxolato) phosphate), LiCl, LiI, LiB(C₂O₄)₂ (lithium bis(oxalato) borate)(LiBOB), or lithium difluoro(oxalato)borate (LiDFOB). A concentration of the lithium salt may range from, e.g., about 0.1 M to about 2.0 M. Maintaining the concentration of the lithium salt within the above concentration range may help ensure that an electrolyte may have excellent performance and lithium ion mobility due to optimal electrolyte conductivity and viscosity.

A separator may be between the positive electrode and the negative electrode depending on a type of a rechargeable lithium battery. The separator may include, e.g., polyethylene, polypropylene, polyvinylidene fluoride or multi-layers thereof having two or more layers and may be a mixed multilayer such as a polyethylene/polypropylene double-layered separator, a polyethylene/polypropylene/polyethylene triple-layered separator, a polypropylene/polyethylene/polypropylene triple-layered separator, or the like.

The FIGURE is an exploded perspective view of a rechargeable lithium battery according to an embodiment. In an implementation, as illustrated in the drawing FIGURE, the rechargeable lithium battery may be a prismatic battery or may include variously-shaped batteries such as a cylindrical battery, a pouch battery, or the like.

As illustrated in the FIGURE, a rechargeable lithium battery 100 according to an embodiment may include an electrode assembly 40 manufactured by winding a separator 30 between a positive electrode 10 and a negative electrode 20 and a case 50 housing the electrode assembly 40. An electrolyte may be impregnated in the positive electrode 10, the negative electrode 20 and the separator 30.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

In an ethanol solvent, a mixing was conducted by pulverizing silicon particles with an average particle diameter of 8 m, nano-sized Ag, and a stearic acid dispersant using zirconia balls for 8 hours. In this procedure, silicon primary particles with an average particle diameter D50 of 100 nm were prepared. A mixing ratio of the silicon particles and the stearic acid dispersant was set to a weight ratio of silicon particle:stearic acid dispersant to be 100:25, and an amount of Ag was adjusted in order to have a weight ratio of silicon and Ag of 100:20.

The mixture was spray-dried to prepare secondary particles having an average particle diameter D50 of 7 μm and pores.

The prepared secondary particle and petroleum pitch were mixed in a weight ratio of 60:40 and the mixture was carbonized at 1,000° C. under an N₂ atmosphere.

Thereafter, the carbonized product was pulverized in order to have span shown in Table 1, thereby preparing a negative electrode active material.

The prepared negative electrode active material included a secondary particle having an average particle diameter D50 of 7 μm, where silicon primary particles having an average particle diameter D50 of 100 nm, surrounded by Ag at a thickness of 20 nm (thickness of Ag coating layer: 20 nm), are agglomerated, and a soft carbon coating layer coated on the primary particles and the secondary particle, and including Ag.

Based on the total weight of the negative electrode active material, an amount of Ag was 10 wt %, an amount of the silicon nanoparticles was 50 wt %, and the amount of the soft carbon was 40 wt %.

97.5 wt % of the prepared negative electrode active material, 1.5 wt % of carboxymethyl cellulose, and 1 wt % of a styrene butadiene rubber were mixed in a water solvent to prepare a negative electrode active material layer slurry.

The negative electrode active material layer slurry was coated on a Cu foil current collector, dried, and pressurized to prepare a negative electrode active material layer, thereby preparing a negative electrode.

The negative electrode, a lithium metal counter electrode, and an electrolyte were used to fabricate a half-cell by the general procedures. The electrolyte was a 1 M LiPF₆ solution in a mixed solvent of ethylene carbonate and dimethyl carbonate (3:7 volume ratio).

The negative electrode, a LiCoO₂ positive electrode, and an electrolyte were used to fabricate a coin-type full cell. The electrolyte was a 1 M LiPF₆ solution in a mixed solvent of ethylene carbonate and dimethyl carbonate (3:7 volume ratio).

### Example 2

A negative electrode, a half-cell, and a coin-type full cell were fabricated by the same procedure as in Example 1, except that the pulverization was carried out in order to have span of 1.5, thereby preparing a negative electrode active material.

### Example 3

A negative electrode, a half-cell, and a coin-type full cell were fabricated by the same procedure as in Example 1, except that a negative electrode active material whose amount of Zn was 10 wt % and span was 1.1, was prepared by using Zn instead of Ag.

### Example 4

A negative electrode, a half-cell, and a coin-type full cell were fabricated by the same procedure as in Example 1, except that Ag was used in order to have a mixing ratio of silicon and Ag at a weight ratio of 100:6 to prepare a negative electrode active material having span of 1.1, an amount of Ag of 3 wt % based on the total weight of the negative electrode active material, secondary particles with an average particle diameter D50 of 7 μm where silicon primary particle with an average particle diameter D50 of 100 nm coated with Ag at a 5 nm thickness, and a soft carbon coating layer including Ag. In the prepared negative electrode active material, an amount of Ag was 3 wt %, an amount of the silicon nanoparticles was, and the amount of the soft carbon was 40 wt %, based on the total weight of the prepared negative electrode active material.

### Comparative Example 1

A negative electrode active material with span 1.1 was prepared without using Ag. The negative electrode active material was used to fabricate a negative electrode, a half-cell, and a coin-type full cell by the same procedure as in Example 1.

### Comparative Example 2

In an ethanol solvent, a mixing was conducted by pulverizing silicon particles with an average particle diameter of 8 μm and a stearic acid dispersant using a zirconia ball for 8 hours. In this procedure, silicon primary particles with an average particle diameter D50 of 100 nm were prepared. A mixing ratio of the silicon particles and the stearic acid dispersant was set to a weight ratio of silicon particle:stearic acid dispersant to be 100:25.

Nano-sized Ag was added to the resulting product at a mixing ratio of silicon and Ag to be a weight ratio of 100:20, and then spray-dried to prepare secondary particles having an average particle diameter D50 of 7 μm and pores.

The prepared secondary particle was primarily heat-treated at 350° C. under an air atmosphere for 1 hour.

The prepared secondary particle and petroleum pitch were mixed at a weight ratio of 60:40, and the mixture was carbonized at 1,000° C. under an N₂ atmosphere to prepare a negative electrode active material.

The prepared negative electrode active material included a secondary particle having an average particle diameter D50 of 7 μm where silicon primary particles having an average particle diameter D50 of 100 nm were agglomerated, Ag was point-contacted with the surface of the primary particles, and a soft carbon coating layer coated on the primary particles and the secondary particle, and including Ag.

Based on the total weight of the negative electrode active material, an amount of Ag was 10 wt %, an amount of the silicon nanoparticles was 50 wt %, and the amount of the soft carbon was 40 wt %.

The negative electrode active material was used to fabricate a negative electrode, a half-cell, and a coin-type full cell by the same procedure as in Example 1.

### Comparative Example 3

In an ethanol solvent, a mixing was conducted by pulverizing silicon particles with an average particle diameter of 8 μm and a stearic acid dispersant using a zirconia ball for 8 hours. In this procedure, silicon primary particles with an average particle diameter D50 of 100 nm were prepared. A mixing ratio of the silicon particles and the stearic acid dispersant was set to a weight ratio of silicon particle:stearic acid dispersant to be 100:25.

The resulting product was spray-dried to prepare secondary particles having an average particle diameter D50 of 7 μm and pores.

The prepared secondary particle and petroleum pitch were mixed at a weight ratio of 60:40, and the mixture was carbonized at 1,000° C. under an N₂ atmosphere to prepare a Si-carbon composite including secondary particle having an average particle diameter D50 of 7 μm where silicon primary particles having an average particle diameter D50 of 100 nm were agglomerated, and a soft carbon coating layer coated on the primary particles and the secondary particles.

The Si-carbon composite and Ag were mixed at a weight ratio of 100:10 to prepare a negative electrode active material.

The negative electrode active material was used to fabricate a negative electrode, a half-cell, and a coin-type full cell by the same procedure as in Example 1.

### Comparative Example 4

Silicon particles with an average particle diameter of 8 μm and a stearic acid dispersant were pulverized using zirconia balls for 8 hours to prepare silicon primary particles having an average particle diameter D50 of 100 nm.

The silicon primary particles and Ag₂Si were mixed and then spray-dried to prepare secondary particles having an average particle diameter D50 of 7 μm and pores.

An amount of Ag₂Si was used in order to have an amount of Ag to be 10 wt % based on the total 100 wt % of the final negative electrode active material.

The prepared secondary particle and petroleum pitch were mixed at a weight ratio of 60:40, and the mixture was carbonized at 1,000° C. under an N₂ atmosphere to prepare a negative electrode active material.

The prepared negative electrode active material included a secondary particle having an average particle diameter D50 of 7 μm including silicon primary particles having an average particle diameter D50 of 100 nm agglomerated with Ag₂Si and a soft carbon coating layer coated on the primary particles and the secondary particle, and including Ag.

The negative electrode active material was used to fabricate a negative electrode, a half-cell, and a coin-type full cell by the same procedure as in Example 1.

### Experimental Example 1: Evaluation of Span

D10, D50, and D90 of the negative electrode active materials of Examples 1 to 4 and Comparative Examples 1 to 4 were measured using a particle analyzer (Product name: LS 13 320, Manufacturer: Beckman Coulter). The results are shown in Table 1. From these values, span defined by Equation 1 was obtained. The results are shown in Table 1.

### Experimental Example 2: Evaluation of XRD Characteristic of Negative Electrode Active Material

Regarding the negative electrode active materials of Examples 1 to 4 and Comparative Examples 1 to 4, an X-ray diffraction analysis (XRD, X-ray Diffraction) was carried out by using a CuKα ray to a peak intensity ratio (I_{Ag(111)}/I_{Si(111)}) of a peak intensity (I_{Ag(111)}) at a (111) plane of Ag relative to a peak intensity (I_{Si(111)}) at a (111) plane of Si. The peak intensity ratio was defined as the height ratio of the peak. The results of Examples 1 to 4, and Comparative Examples 2 and 4 are shown in Table 1.

### Experimental Example 3: Evaluation of Charge and Discharge Efficiency

The half-cells according to Examples 1 to 4 and Comparative Examples 1 to 4 were once charged and discharged at 0.1 C, and a ratio of the measured discharge capacity relative to the measured charge capacity was calculated. The results are shown in Table 1, as efficiency.

### Experimental Example 4: Evaluation of Rate Capability

The half-cells according to Examples 1 to 4 and Comparative Examples 1 to 4 were once charged and discharged at 0.2 C, and then once charged and discharged at 2 C. A ratio of charge capacity at 2 C relative to charge capacity at 0.2 C was calculated. The results are shown in Table 1, as charge rate capability.

### Experimental Example 5: Evaluation of Accelerated Life

The coin-type full cells according to Examples 1 to 3 and Comparative Examples 1 to 5 were charged and discharged at 1 C for 500 cycles. A ratio of discharge capacity at 1^{st} cycle relative to discharge capacity at 500^{th} cycle was calculated. The results are shown in Table 1.

TABLE 1

| | | | | | | | Charge rate | Accelerated |
|---|---|---|---|---|---|---|---|---|
| | D90 | D50 | D10 | | Peak intensity ratio | Efficiency | capability | life |
| | (μm) | (μm) | (μm) | Span | (IAg(111)/Si(111)) | (%) | (%) | (%) |
| Example 1 | 13.7 | 8.2 | 4.7 | 1.1 | 0.38 | 91 | 45.5 | 91.5 |
| Example 2 | 16.9 | 8.5 | 3.9 | 1.5 | 0.38 | 90.4 | 43.3 | 91.3 |
| Example 3 | 13.7 | 8.2 | 4.7 | 1.1 | 0.40 | 90.6 | 43.5 | 91.2 |
| Example 4 | 13.7 | 8.2 | 4.7 | 1.1 | 0.07 | 90.6 | 42.5 | 91.0 |
| Comparative | 13.7 | 8.2 | 4.7 | 1.1 | — | 90.6 | 42 | 90.5 |
| Example 1 | | | | | | | | |
| Comparative | 13.7 | 8.2 | 4.7 | 1.1 | 0.38 | 89.8 | 42.6 | 90.7 |
| Example 2 | | | | | | | | |
| Comparative | 13.7 | 8.2 | 4.7 | 1.1 | — | 84.1 | 42.3 | 6.1 |
| Example 3 | | | | | | | | |
| Comparative | 13.7 | 8.2 | 4.7 | 1.1 | 0.35 | 82.5 | 37.2 | 84.4 |
| Example 4 | | | | | | | | |

As shown in Table 1, the cells including the negative electrode active materials of Examples 1 to 4 exhibited high efficiency and charge rate capability, and excellent accelerated life. Whereas, Comparative Example 1, which did not include Ag, exhibited deteriorated charge rate capability and an accelerated life.

Comparative Example 2 in which Ag was positioned at a point-contacted with the surface of the silicon primary particles, exhibited low charge and discharge efficiency. Comparative Example 3 using the negative electrode active material in which the Si-carbon composite and Ag were simply mixed, exhibited remarkably low charge and discharge efficiency and low charge rate capability, and showed the accelerated life of 6.1% which was significantly deteriorated.

Comparative Example 4, using the negative electrode active material in which the Si-carbon composite and the Si—Ag compound were mixed, showed extremely deteriorated charge and discharge efficiency, charge rate capability, and accelerated life.

By way of summation and review, one or more embodiments provides a negative electrode active material exhibiting excellent conductivity. Another embodiment provides a rechargeable lithium battery including the negative electrode active material.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A negative electrode active material, comprising:
primary particles comprising silicon nanoparticles, and a metal coating layer comprising a metal material surrounding a surface of each of the silicon nanoparticles;
a secondary particle where the primary particles are agglomerated; and
an amorphous carbon coating layer surrounding a surface of the primary particles and a surface of the secondary particle,
wherein the negative electrode active material has a span as defined by Equation 1 of about 1.1 to about 1.6,
$$Span = ( D 90 - D 10 ) / D 50 \qquad [ Equation 1 ]$$
wherein, D10 indicates a diameter of particles having a cumulative volume of 10 volume % in a particle size distribution, D50 indicates a diameter of particles having a cumulative volume of 50 volume % in the particle size distribution, and D90 indicates a diameter of particles having a cumulative volume of 90 volume % in the particle size distribution.

2. The negative electrode active material as claimed in claim 1, wherein the span is about 1.1 to about 1.5.

3. The negative electrode active material as claimed in claim 1, wherein the metal material comprises a metal or a metal compound.

4. The negative electrode active material as claimed in claim 3, wherein the metal compound comprises a metal oxide, a metal nitride, or a combination thereof.

5. The negative electrode active material as claimed in claim 1, wherein the metal material comprises a metal capable of alloying with lithium.

6. The negative electrode active material as claimed in claim 5, wherein the metal comprises an alkali metal, an alkaline-earth metal, a Group 13 element, a Group 14 element, a Group 15 element, a Group 16 element, a transition metal, a rare earth element, or a combination thereof.

7. The negative electrode active material as claimed in claim 6, wherein the metal comprises Ag, Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, or a combination thereof.

8. The negative electrode active material as claimed in claim 7, wherein the metal comprises Ag.

9. The negative electrode active material as claimed in claim 1, wherein an amount of the metal material is about 0.01 wt % to about 20 wt %, based on a total weight of the negative electrode active material.

10. The negative electrode active material as claimed in claim 1, wherein an amount of the metal material is about 0.05 wt % to about 15 wt %, based on a total weight of the negative electrode active material.

11. The negative electrode active material as claimed in claim 1, wherein the amorphous carbon coating layer further comprises another metal material.

12. The negative electrode active material as claimed in claim 8, wherein the negative electrode active material has a ratio of a peak intensity (I_{metal 111}/I_{Si 11}) of a diffraction peak intensity (Iₘₑₜₐₗ₍₁₁₁₎) derived from a metal(111) detected at 2θ=about 37.5° to about 40.0° relative to a diffraction peak intensity (I_{Si(111)}) derived from Si(111) detected at 2θ=about 27.5° to about 29.5° of about 0.05 to about 0.5 in measurement of X-ray diffraction intensity.

13. The negative electrode active material as claimed in claim 1, wherein the metal coating layer continuously covers the surface of each of the silicon nanoparticles.

14. The negative electrode active material as claimed in claim 1, wherein the metal coating layer has a thickness of about 1 nm to about 30 nm.

15. The negative electrode active material as claimed in claim 1, wherein the silicon nanoparticles have a particle diameter of about 10 nm to about 1,000 nm.

16. The negative electrode active material as claimed in claim 1, wherein the silicon nanoparticles have a particle diameter of about 10 nm to about 200 nm.

17. The negative electrode active material as claimed in claim 1, wherein the amorphous carbon coating layer has a thickness of about 1 nm to about 2 μm.

18. The negative electrode active material as claimed in claim 1, wherein an amount of the silicon nanoparticle is about 44 wt % to about 65 wt %, based on a total weight of the negative electrode active material.

19. The negative electrode active material as claimed in claim 1, wherein an amount of the amorphous carbon coating layer is about 34 wt % to about 46 wt %, based on a total weight of the negative electrode active material.

20. A rechargeable lithium battery, comprising:
a negative electrode comprising the negative electrode active material of claim 1;
a positive electrode; and
an electrolyte.
